(19) United States
(12) Patent Application Publication
(10) Pub. No.: US 2009/0263526 A1
(43) Pub. Date: Oct. 22, 2009

(54) POSITION MECHANISM

(75) Inventors: Chih-Yu CHEN, Taipei Hsien (TW); Jian-Guang HUANG, Taipei Hsien (TW); Chun-Yan WU, Taipei Hsien (TW); Guo-Ning LIANG, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/104,829

(22) Filed: Apr. 17, 2008

(51) Int. Cl. B29C 45/14

(52) U.S. Cl. 425/110

(57) ABSTRACT

The present invention provides a position mechanism including a locating body. The locating body defines a locating cavity and a receiving chamber communicating with the locating cavity. A locating stopper is received in the receiving chamber of the locating body with an end thereof toward the locating cavity, and an elastic component is received in the receiving chamber of the locating body and resiliently biases the locating stopper into the locating cavity.

### BACKGROUND OF THE INVENTION

1. Field of the Invention

The present invention relates to a position mechanism, and more particularly to a position mechanism used in an injection mold for positioning a semi-finished product to be shaped into a finished product in the injection mold.

2. The Related Art

The injection molding technology is widely used in the mold field for shaping a plastic product. Generally, different parts of the plastic product are made from different kinds of material, so that the plastic product needs to be positioned and shaped for several times. Supposing that the plastic product is made from two different kinds of material, the plastic product needs to be shaped for two times. Correspondingly, a mold where the plastic product is shaped includes a first injection molding apparatus and a second injection molding apparatus for shaping the plastic product. A part of the plastic product is shaped in the first injection molding apparatus of the mold using one kind of the material, and then the plastic product is positioned in the second injection molding apparatus of the mold for shaping another part thereof using the other kind of the material.

However, conventionally, after the plastic product is shaped for the first time in the first injection molding apparatus, the plastic product is semi-finished and then the semi-finished plastic product is positioned in the second injection molding apparatus to be shaped into a finished plastic product through a conventional position mechanism which is adopted to locate the semi-finished plastic product via position pins, locating blocks or other simple components. Because the plastic product is easily driven rotating or moving by external force in the process of being shaped, the conventional position mechanism cannot guarantee the position precision, that is, the shaping quality of the plastic product has no security. If the plastic product is driven rotating or moving in the process of being shaped into the finished plastic product, the finished plastic product maybe has defects and is unserviceable and has to be discarded, which wastes material.

### SUMMARY OF THE INVENTION

Accordingly, an object of the present invention is to provide a position mechanism used in an injection mold for positioning a semi-finished product to be shaped into a finished product in the injection mold. The position mechanism includes a locating body defining a locating cavity and a receiving chamber communicating with the locating cavity. A locating stopper is received in the receiving chamber of the locating body with an end thereof toward the locating cavity. And an elastic component is received in the receiving chamber of the locating body and resiliently biases the locating stopper into the locating cavity.

As described above, after a product is shaped in the injection mold for one time, the product is semi-finished and named the semi-finished product. Then the semi-finished product is placed in the locating cavity of the locating body. The semi-finished product compresses the locating stopper to make the locating stopper move sideward. At the same time, the elastic force of the elastic component pushes the locating stopper to move toward the locating cavity. Then, the semi-finished product is firmly located in the locating cavity, which avoids the semi-finished product rotating or moving in the process of being shaped into the finished product. Therefore, the position precision of the position mechanism is raised, which ensures the shaping quality of the finished product.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a position mechanism according to the present invention;

FIG. 2 is a cross-sectional view of a locating body of the position mechanism taken along line of II-II of FIG. 1;

FIG. 3 is a perspective view of the position mechanism; and

FIG. 4 is a cross-sectional view of the position mechanism taken along line of IV-IV of FIG. 3.

### DETAILED DESCRIPTION OF THE PREFERRED EMBODIMENT

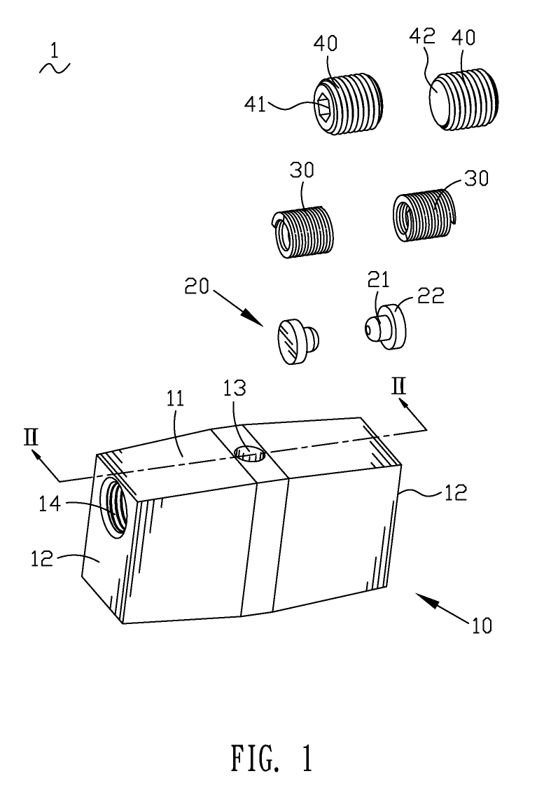

Referring to FIG. 1, a position mechanism 1 used in an injection mold is illustrated that includes a locating body 10, a pair of locating stoppers 20 received in the locating body 10, a pair of coil springs 30 received in the locating body 10 and blocked by the locating stoppers 20 and a pair of screws 40 mounted in the locating body 10 and jamming the coil springs 30.

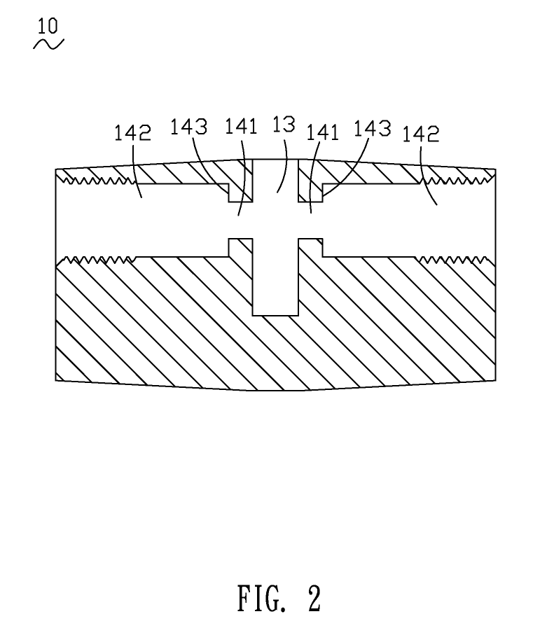

With reference to FIG. 1 and FIG. 2, the locating body 10, the locating stoppers 20, the coil springs 30 and the screws 40 are described in detail. The locating body 10 is substantially rectangular and has a top wall 11 and two sidewalls 12. A locating cavity 13 is defined at the center of the top wall 11 and extends into the inner of the locating body 10. Each of the two sidewalls 12 defines a receiving chamber 14 stretching into the inner of the locating body 10. The receiving chamber 14 has a limiting cavity 141 communicating with the locating cavity 13 and a retaining cavity 142 communicating with the limiting cavity 141 and outside. The diameter of the retaining cavity 142 is greater than the diameter of the limiting cavity 141 in order to define a shoulder 143 therebetween. An inner surface of the retaining cavity 142 machines screw threads adjacent to the outside.

The locating stopper 20 has a column-shaped locating portion 21. An end of the locating portion 21 protrudes therearound to form a resisting portion 22. The locating portion 21 and the resisting portion 22 have the same axle center. The diameter of the resisting portion 22 is greater than the diameter of the locating portion 21. The screw 40 is column-shaped. The screw 40 defines screw threads around an outer surface thereof. The screw 40 has a closed end 42 and the other end opposite the closed end 42 defines an opening 41 for facilitating the screw 40 being assembled in the locating body 10.

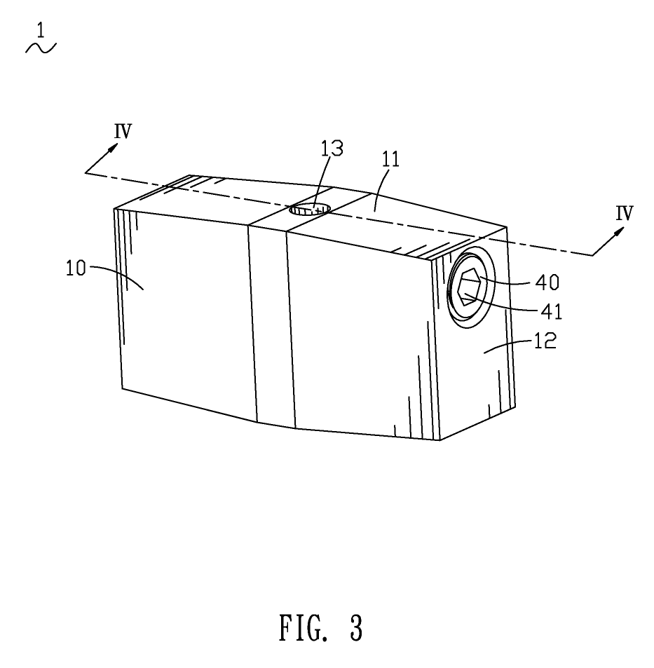

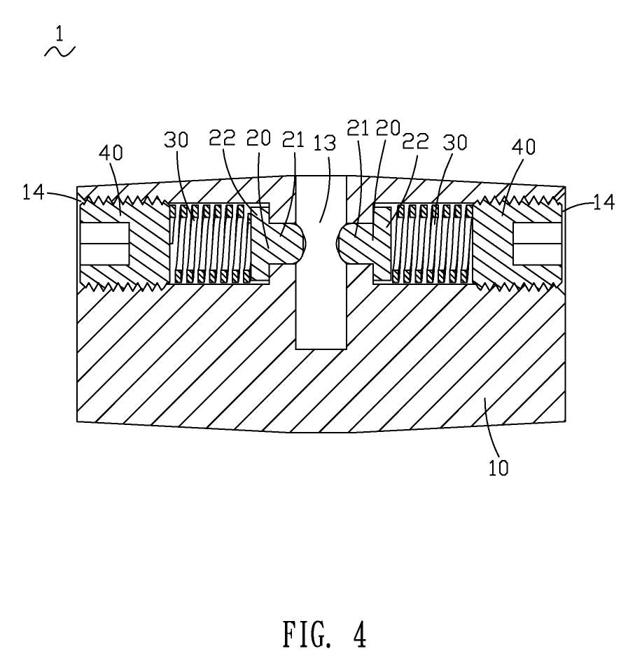

Please refer to FIG. 1, FIG. 3 and FIG. 4. In assembly, the locating stoppers 20 are respectively disposed in the receiving chambers 14 of the locating body 10. The locating portion 21 is received in the limiting cavity 141 and partly protrudes into the locating cavity 13. The resisting portion 22 is received in the retaining cavity 142 and resists against the shoulder 143. The coil springs 30 are respectively disposed in the retaining cavities 142 of the locating body 10. One end of the coil spring 30 is elastically compressed against the resisting portion 22 of the locating stopper 20. The screws 40 are respectively mounted in the retaining cavities 142 of the locating body 10. The screw threads defined on the screw 40 engage with the screw threads defined on the inner surface of the retaining cavity 142 to fix the screw 40 in the retaining cavity 142 firmly. The closed end 42 of the screw 40 presses an opposite end of the coil spring 30.

In use, a plastic product is shaped in the injection mold for two times (not shown). After the plastic product is shaped in the injection mold for one time, the plastic product is semi-finished and named a semi-finished plastic product. Then the semi-finished plastic product is placed in the locating cavity 13 of the locating body 10. The semi-finished plastic product compresses the locating portions 21 of the locating stoppers 20 to make the locating portions 21 move sideward. Then the semi-finished plastic product is located between the locating portions 21. At the same time, the elastic force of the compressed coil springs 30 pushes the locating stoppers 20 to move toward the locating cavity 13. Therefore, the semi-finished plastic product is firmly located between the locating portions 21 in the locating cavity 13, which avoids the semi-finished plastic product rotating or moving in the process of shaping the semi-finished plastic product into a finished plastic product.

As described above, the position mechanism 1 is able to firmly position the semi-finished plastic product through defining the locating cavity 13 and the receiving chambers 14 on the locating body 10 thereof. Then the locating stoppers 20, the coil springs 30 and the screws 40 are disposed in the receiving chambers 14 respectively for firmly positioning the semi-finished plastic product in the locating cavity 13, avoiding the semi-finished plastic product rotating or moving in the process of being shaped into the finished plastic product. Therefore, the position precision of the position mechanism 1 is raised, which ensures the shaping quality of the finished plastic product.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A position mechanism, comprising:
a locating body defining a locating cavity and a receiving chamber communicating with the locating cavity;
a locating stopper received in the receiving chamber of the locating body with an end thereof toward the locating cavity; and
an elastic component received in the receiving chamber and resiliently biasing the locating stopper into the locating cavity.

2. The position mechanism as claimed in claim 1, further comprising a screw mounted in the receiving chamber of the locating body, the screw pressing the elastic component to hold the elastic component and the locating stopper in place.

3. The position mechanism as claimed in claim 1, wherein the receiving chamber has a limiting cavity communicating with the locating cavity and a retaining cavity communicating with the limiting cavity and outside, the diameter of the retaining cavity is greater than the diameter of the limiting cavity in order to define a shoulder therebetween, the locating stopper has a locating portion, an end of the locating portion protrudes therearound to form a resisting portion, the diameter of the resisting portion is greater than the diameter of the locating portion, the locating portion is received in the limiting cavity and protrudes into the locating cavity, the resisting portion is received in the retaining cavity and restricted by the shoulder.

4. The position mechanism as claimed in claim 3, wherein the elastic component is received in the retaining cavity of the receiving chamber, an end of the elastic component is against the resisting portion of the locating stopper, an opposite end of the elastic component is against a screw fixed in the retaining cavity.

5. The position mechanism as claimed in claim 4, wherein the retaining cavity of the receiving chamber defines screw threads on an inner surface thereof, an outer surface of the screw defines screw threads engaging with the screw threads defined on the inner surface of the retaining cavity.

6. The position mechanism as claimed in claim 2, wherein the screw has a closed end, the other end of the screw opposite the closed end defines an opening, the elastic component is against the closed end of the screw.
